(19) United States
(12) Patent Application Publication
(10) Pub. No.: US 2025/0356257 A1
(43) Pub. Date: Nov. 20, 2025

(54) MACHINE LEARNING MODEL WITH GROUNDED CONTENT TOKEN INSERTION

(71) Applicant: Microsoft Technology Licensing, LLC, Redmond, WA (US)

(72) Inventors: Eric Joel HORVITZ, Portola Valley, CA (US); Harsha Prasad NORI, Seattle, WA (US)

(73) Assignee: Microsoft Technology Licensing, LLC, Redmond, WA (US)

(21) Appl. No.: 18/966,040

(22) Filed: Dec. 2, 2024

Related U.S. Application Data
(60) Provisional application No. 63/649,943, filed on May 20, 2024.

(51) Int. Cl. G06N 20/00

(52) U.S. Cl. CPC G06N 20/00

(57) ABSTRACT

A computing system is provided that receives a tokenized prompt at a machine learning model, generates a model-generated content portion of an output sequence of output tokens in response to the tokenized prompt, identifies provenance metadata for a grounded data source in the model-generated content portion of the output sequence. Upon identification of the provenance metadata, the computing system at least temporarily ceases token-wise probabilistic generation of the output sequence with the machine learning model, retrieves grounded content from the grounded data source using the provenance metadata, writes output tokens corresponding to the grounded content to a grounded content portion of the output sequence, and transmits the output sequence to an additional computing process, for display, storage, or additional downstream processing, for example.

### CROSS REFERENCE TO RELATED APPLICATIONS

This application claims priority to U.S. Provisional Patent Application Ser. No. 63/649,943, filed May 20, 2024, the entirety of which is hereby incorporated herein by reference for all purposes.

### BACKGROUND

In recent years, generative machine learning models have achieved impressive results. These models have been applied to generative tasks in such diverse fields as natural language generation, computational chemistry, image and video generation, and generation of computer code. The largest generative models have the ability to produce output that closely resembles human output and score high on accuracy benchmarks for certain tasks. However, as discussed below, this accuracy comes at a cost, and is not always achievable for all types of model interactions. Therefore, as these generative models continue to be developed, opportunities exist to improve their accuracy and efficiency.

### SUMMARY

A computing system is provided that receives a tokenized prompt at a machine learning model, generates a model-generated content portion of an output sequence of output tokens in response to the tokenized prompt, identifies provenance metadata for a grounded data source in the model-generated content portion of the output sequence. Upon identification of the provenance metadata, the computing system at least temporarily ceases token-wise probabilistic generation of the output sequence with the machine learning model, retrieves grounded content from the grounded data source using the provenance metadata, writes output tokens corresponding to the grounded content to a grounded content portion of the output sequence, and transmits the output sequence to an additional computing process, for display, storage, or additional downstream processing, for example.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system that implements a machine learning model configured to perform grounded content token insertion during inference, according to a first example configuration of the present disclosure.

FIG. 2 shows a schematic view of the computing system of FIG. 1, illustrating a machine learning model that generates an output sequence of output tokens, and a model plugin postprocessor that examines the output sequence during generation, determines that grounded content should be written into the output sequence, retrieves grounded content from a grounded content source, and directly writes output tokens for the grounded content into the output sequence.

FIG. 3 shows a schematic view of a computing system that implements a machine learning model configured to perform grounded content token insertion during inference, according to a second example configuration of the present disclosure.

FIG. 4 shows a schematic view of the computing system of FIG. 3, illustrating an example prompt with a grounded data source indicated therein, and a corresponding response with model-generated tokens and grounded content tokens inserted by a grounded content module of a preprocessor of a model plugin of the machine learning model.

FIG. 5 shows a schematic view of the configuration of FIG. 3, illustrating another example prompt with grounded data source and corresponding response with model-generated tokens and grounded content tokens inserted by a grounded content module of a postprocessor of a model plugin of the machine learning model.

FIG. 6 is a flowchart of a computerized method for implementing a machine learning model that performs grounded content token insertion, according to a first example implementation of the present disclosure.

FIG. 7A is a flowchart of a computerized method for implementing a machine learning model that performs grounded content token insertion, according to a second example implementation of the present disclosure.

FIG. 7B is a continuation of the flowchart of the computerized method of FIG. 7A.

FIG. 7C is a continuation of the flowchart of the computerized method of FIG. 7B.

FIG. 8 is a flowchart of a computerized method for implementing a machine learning model that performs grounded content token insertion, according to a third example implementation of the present disclosure.

FIG. 9 shows a schematic view of an example computing environment in which the computing system of FIGS. 1-5 may be enacted.

### DETAILED DESCRIPTION

As discussed above, generative machine learning models have progressed in development to a point where on many classes of tasks, their output closely resembles human output. For pretrained transformer-based language models, for example, accuracy on benchmarks has generally increased with parameter size, with the largest models now exceeding hundreds of billions of parameters. At this scale, such models suffer from drawbacks in terms of efficiency and accuracy. Regarding efficiency, training and inference using such large models consumes significant compute resources, energy, and time. Regarding accuracy, the probabilistic nature of such models can lead to instances of model hallucination, where the model responds to a prompt with inaccurate information not contained in its training data. Further, the output of such models can vary, even in response to the same or similar inputs, making them unstable and unusable in applications that require reliable and stable outputs. In addition, there are limits on the scope of the training data for any generative model. For example, training data may not include inaccessible private data or data that is extremely recent. As a result of these limitations, a generative model might respond inaccurately to a prompt with stale or incorrect information.

One prior approach to address these issues is to augment a prompt to a language model using retrieval augmented generation that retrieves information related to the prompt from a grounded data source that has been deemed trustworthy. The retrieved information from the grounded data source is used to augment the prompt (e.g., by appending the retrieved information to the prompt) and the augmented prompt is sent to the language model for response generation. The generative model generates a response based both on the original information contained in the augmented prompt and the retrieved information from the grounded data source that is also contained in the augmented prompt.

One drawback with retrieval augmented generation using grounded data sources is that it results in lengthy prompts being sent to the generative model, thereby increasing the compute resources, energy, and time consumed during inference. Another drawback with this approach is that the information from the grounded data source is processed as model input in a probabilistic manner during inference by the model, and thus there is no guarantee that the grounded content will appear accurately or reliably in the output.

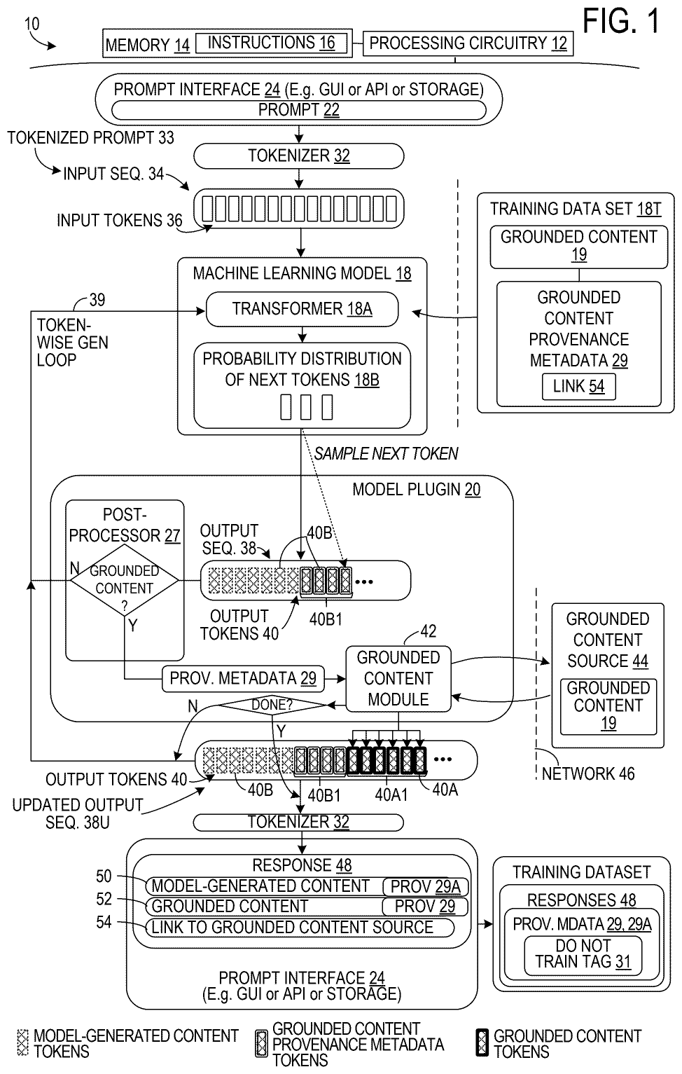

To address the issues described above, a computing system 10 is provided, as shown in FIG. 1. Computing system 10 includes processing circuitry 12 and associated memory 14 storing instructions 16 that when executed cause the processing circuitry 12 to perform the following functions. The processing circuitry 12 is configured to instantiate a trained machine learning model 18, and to instantiate a model plugin 20. The model plugin 20 is configured to provide an interface to the machine learning model 18, to enable user-defined functionality to be implemented at the machine learning model 18. The model plugin 20 can be provided as an additional piece of software that is installed in an existing machine learning model 18, or can be incorporated into machine learning model 18 as a native interface. The machine learning model 18 can include transformer 18A. Accordingly, the machine learning model 18 can be a generative transformer-based model including an encoder-decoder architecture or decoder-only architecture, for example. The transformer-based machine learning model 18 can be single mode or multi-modal. The inputs in a single mode or multi-modal configuration may include natural language input, image input, video input, audio waveform input, and/or parameterized data input from a data feed, as some examples. The machine learning model 18 can be a generative large language model having billions of parameters, such as GPT-3.5, GPT-4o, ORCA-2, or LLAMA-2, as some specific examples.

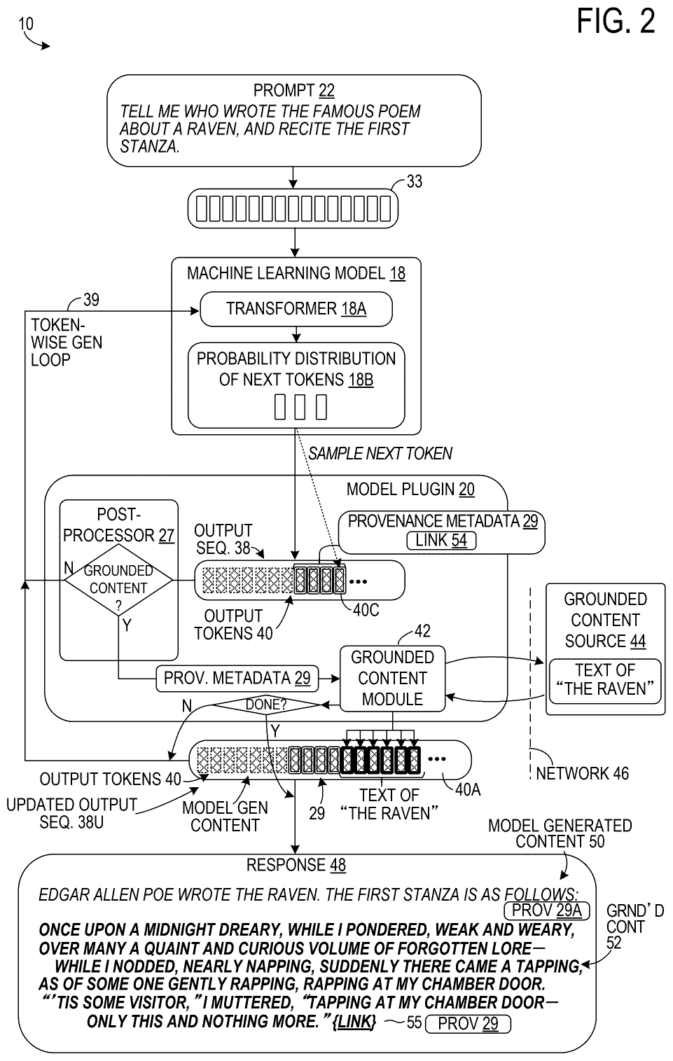

During training, the transformer 18A of machine learning model 18 is trained on a training data set 18T that includes grounded content 19 encoded with associated grounded content provenance metadata 29. The grounded content provenance metadata 29 can include a link 54, such as a URL, to a grounded content source 44 at which the grounded content 19 can be accessed. As an example, the provenance metadata 29 may be encoded in a JSON format, which may include keys identifying the title, author, and year of publication of a public domain work or other work of authorship, for example. The provenance metadata 29 may also include partial or full text, images, video, and/or audio associated with the grounded content 19. In the example of FIG. 2, an entry for Edgar Allen Poe's poem The Raven is discussed, which could be included in the training data set 18T. By including the provenance metadata 29 in the training data set 18T, it will be appreciated that the machine learning model 18 will be trained to output the provenance metadata 29 for a particular piece of grounded content 19 when users make queries for that grounded content 19 during inference.

During inference, a prompt 22 is received via a prompt interface 24. The prompt interface 24 can be a graphical user interface of a program such as a chatbot, browser, or productivity application, in one set of examples, or an application programming interface, in another example. The prompt 22 is made up of text data, which can include unstructured text such as natural language input. When using a multimodal model, the prompt 22 may include other input modalities, such as images, video, or audio. The prompt 22 is passed through a tokenizer 32 to generate a tokenized prompt 33 including an input sequence 34 of input tokens 36.

The processing circuitry 12 is configured to receive at the machine learning model 18 the tokenized prompt 33. In response to receiving the tokenized prompt, transformer 18A of the machine learning model 18 generates a model-generated content portion of the output sequence 38 of output tokens 40 in response to the tokenized prompt 33. The model-generated content portion includes model-generated output tokens 40B, as shown. As shown at token-wise generation loop 39, the generation of the output sequence 38 proceeds in token-wise fashion, autoregressively generating one token at a time based on the tokenized prompt 33 and the current state of the output sequence 38, until a termination condition is reached.

During execution of the token-wise generation loop 39, a post-processor 27 of the model plugin 20 for the machine learning model 18 is configured to examine the output tokens 40 in the output sequence 38, and to identify grounded content provenance metadata tokens 40B1 (i.e., tokenized provenance metadata 29) for a grounded data source 44 in the model-generated content portion of the output sequence 38. The model-generated content portion includes model-generated output tokens 40B, and among these model-generated tokens 40B, those that encode grounded content provenance metadata 29 are referred to as grounded content provenance metadata tokens 40B1.

Upon identifying the grounded content provenance metadata tokens 40B1 via the post processor, the model plugin 20 is configured to at least temporarily cease token-wise probabilistic generation of the output sequence in the generation loop 39 with the machine learning model 18. The post-processor 27 instructs a grounded content module 42 to retrieve grounded content from the grounded data source 44 using the provenance metadata 29 encoded in the grounded content provenance metadata tokens 40B1. Typically, this interaction occurs over a network 46 such as the internet, but may also traverse a local area network, for example. This provenance metadata 29, as described above, can include link 54 to a location on the grounded content source 44 at which the grounded content 19 can be accessed and downloaded.

The grounded content module 42 of the model plugin 20 is configured to write grounded content output tokens 40A corresponding to the grounded content 19 retrieved from the grounded content source 44 to a grounded content portion 40A1 of the output sequence 38, to thereby form an updated output sequence 38U. The model plugin 20 is configured to transmit the updated output sequence 38U to an additional computing process, such as a graphical user interface (GUI), downstream application program, or storage process, for example.

As shown, the updated output sequence 38U can be passed through a tokenizer 32 for detokenization, and a response 48 can be generated. The response 48 includes text data including model-generated content 50 based on the model-generated content portion (i.e., model-generated tokens 40B) of the updated output sequence 38U, grounded content 52 based on the grounded content portion 40A1 of the updated output sequence 38U, and a link 54 to the grounded content 19 at the grounded data source 44, which can be encoded using grounded content provenance metadata tokens 40B1. Provenance metadata 29, 29A for the grounded content 52 and model-generated content 50, respectively, can be included in the response 48. Unlike provenance metadata 29, provenance metadata 29A for the model-generated content 50 includes information regarding generation via machine learning model 18 and model plugin 20, but does not include information regarding grounded content source 44 as the model-generated content 50 was not retrieved from such source.

Response 48 can be output to prompt interface 24. Thus, in one example, the additional computing process mentioned above can be a graphical user interface (GUI), and the processing circuitry 12 can be configured to transmit the output sequence 38 for display at the GUI with the model-generated content 50 and the grounded content 52 indicated in a visually distinguishable manner. The text associated with the grounded content 52 can be labeled at the GUI with an indicator of the grounded data source 44, such as a link 54 to the grounded data source 44. Examples of this are illustrated in FIG. 2 discussed below, where model-generated content 50 is in plain text and grounded content 52 is in bold text. Of course, other forms of emphasis could be used such as color, size, font, outlining, underlining, highlighting, citations, etc. In another example, the prompt interface 24 can be an API or storage interface and the additional computing process can be a downstream computing program such as the prompt API or storage interface.

The computing system 10 can be configured to use the grounded content token insertion techniques described herein to insert a do-not-train tag 31 into the updated output sequence 38U, to thereby prevent or inhibit training of third-party models based on the output of machine learning model 18 and/or of grounding data source 44. To this end, the processing circuitry 12 can be configured to tag the grounded content 52 with the provenance metadata 29 as first provenance metadata, and/or tag the model-generated content 50 with second provenance metadata 29A indicating machine-learning-model-generated output. The processing circuitry 12 further can be configured to exclude the updated output sequence 38U and response 48 from a training corpus of an additional machine learning model based at least in part on determining that the output sequence is tagged with the first provenance metadata 29 or the second provenance metadata 29A. This could be achieved by inserting do-not-train tag 31 associated with the model-generated content 50 and/or grounded content 52 in the training data, as appropriate. In this way, the output of the machine learning model 18 and/or the output of the grounded data source 44 can be avoided when training the additional machine learning model.

Turning now to FIG. 2, an example use case scenario of the computing system 10 of FIG. 1 will be described. As components of FIG. 2 are similar to FIG. 1, they will not be redescribed except where illustrative of this use case. As shown, a prompt 22 is received requesting the machine learning model 18 to explain who wrote the famous poem “The Raven” and to recite the first stanza of the poem. The machine learning model 18 receives the tokenized prompt 33 and begins to generate the output sequence 38, token by token. The first sentence generated by the machine learning model explains, “Edgar Allen Poe wrote The Raven. The first stanza is as follows:” Since this text is model-generated and was not present in the training data for The Raven poem itself, it did not contain provenance metadata, and thus was generated probabilistically following token-wise generation loop 39. Next, the machine learning model 18 begins outputting provenance metadata 29 encoded in grounded content provenance metadata tokens 40C (example: {“Title”: “The Raven”, “URI:example_uri/path#parameters”}, at which point the post processor 27 recognizes the provenance metadata 29 for the grounded content 52, and passes it to the grounded content module 42. The grounded content module 42 uses the link in the tokens 40C to download the grounded content 19 (first stanza of The Raven) from the grounded content source 44, and displays it in the response 48. In this way, the response includes both probabilistically generated content from the model 18, and deterministically generated content from the grounded content source. As used herein probabilistically generated content refers to content that is generated using a generation loop of a trained generative machine learning model that probabilistically predicts an output sequence of the content, whereas deterministically generated content refers to content that is retrieved and directly written to the output sequence with certainty and not probabilistically generated. This ensures the accuracy of the content downloaded from the grounded content source 44, while also improving model efficiency by avoiding calls to the machine learning model 18 to generate text for the first stanza of the poem.

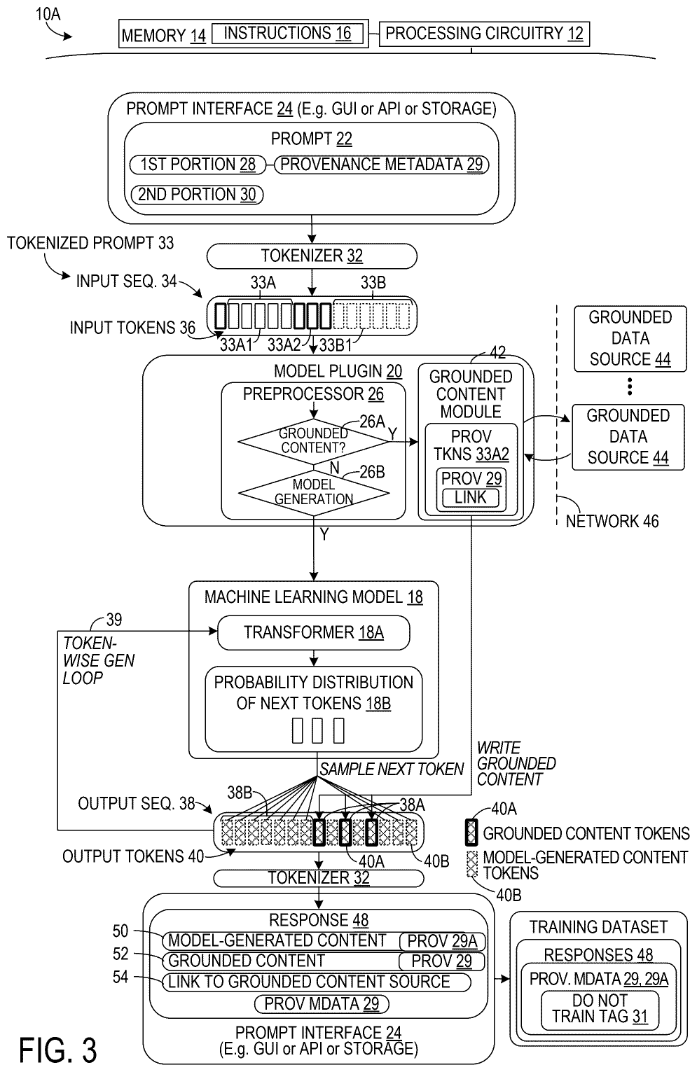

Turning now to FIG. 3, a second configuration of a computing system 10A according to the present disclosure is illustrated. Computing system 10A includes processing circuitry 12 and associated memory 14 storing instructions 16 that when executed cause the processing circuitry 12 to perform the following functions. The processing circuitry 12 is configured to instantiate a trained machine learning model 18, and to instantiate a model plugin 20. The model plugin 20 is configured to provide an interface to the machine learning model 18, to enable user-defined functionality to be implemented at the machine learning model 18. The model plugin 20 can be provided as an additional piece of software that is installed in an existing machine learning model 18, or can be incorporated into machine learning model 18 as a native interface. The machine learning model 18 can be a generative transformer-based model including an encoder-decoder, encoder only, or decoder-only architecture. The transformer-based machine learning model 18 can be single mode or multi-modal. The inputs in a single mode or multi-modal configuration may include natural language input, image input, video input, audio waveform input, and/or parameterized data input from a data feed, as some examples. The machine learning model 18 can be a generative large language model having billions of parameters, such as GPT 3.5, GPT 4o, ORCA-2, or LLaMA-2, as some specific examples.

During inference, a prompt 22 is received via a prompt interface 24. The prompt interface 24 can be a graphical user interface of a program such as a chatbot, browser, or productivity application, in one set of examples, or an application programming interface, in another example. The prompt 22 is made up of text data, which can include unstructured text such as natural language input, and can also include structured text that can be interpreted by a preprocessor 26 or postprocessor 27 (see FIG. 2) in the model plugin 20. The prompt 22 include a first prompt portion 28 and a second prompt portion 30. When using a multimodal model, the prompt 22 may include other input modalities, such as images or audio.

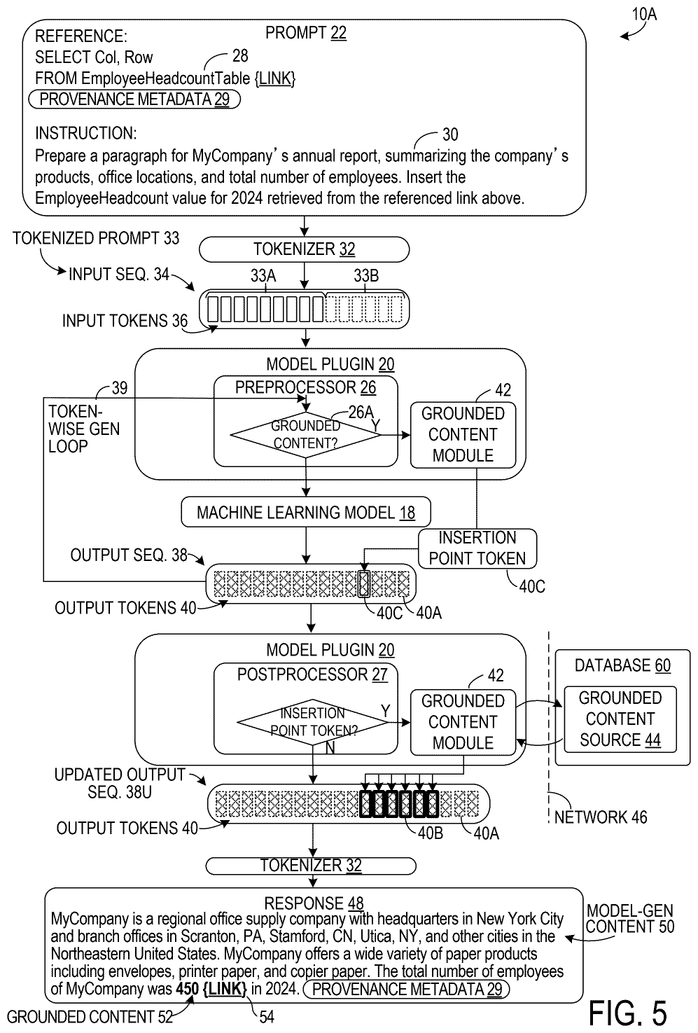

The first prompt portion 28 includes associated provenance metadata 29 indicating a grounded data source 44 for retrieving grounded content 52. For example the first prompt portion 28 can be in the form of structured text that defines how the data retrieved from the grounded data source 44 should be presented in the output sequence 38. As one specific example, the first prompt portion 28 may be a code listing encoded in JavaScript object notation (JSON) that defines keys and values, and the provenance metadata 29 can include a link to a grounded data source 44 to fill in a value associated with a key defined in the JSON code listing. As yet another example discussed in greater details below, the grounded data source 44 can be in a database 60 (see FIG. 5, discussed below) and the first provenance metadata 29 can include a location of the grounded data source 44 in the database 60. The processing circuitry 12 is configured to obtain the first output portion 38A at least in part by performing a database lookup operation at the database 60. As another example, the first portion 28 can include a natural language prompt and the grounded data source 44 can be a language model that has been fine-tuned with particular domain knowledge and equipped with post generation verification logic to increase its accuracy. In yet another example, the first provenance metadata includes author information associated with a verified user account. In this manner, the provenance metadata can identify the original author of the first prompt portion 28 of the prompt 22.

The second prompt portion 30 can include one or more instructions for the machine learning model 18, as well as contextual data relating to how the prompt should be answered, such as intended author, audience, style, length, and language of the desired response. Background material for context or source document snippets may also be included in the second prompt portion 30.

Prompt 22 is passed through a tokenizer 32, which tokenizes the text and other data in the prompt 22 to thereby produce a tokenized prompt 33 including an input sequence 34 of input tokens 36. The preprocessor 26 of the model plugin 20 is configured to receive the tokenized prompt 33. It will be appreciated that the tokenized prompt 33 includes a first prompt portion 33A including one or more first input tokens 33A1 that are tagged with first provenance metadata tokens 33A2 indicating a grounded data source 44, and a second prompt portion 33B including one or more second input tokens 33B1 without the first provenance metadata.

The grounded data source 44 is typically accessed by the grounded content module 42 via a network 46, such as the internet or a local area network. The preprocessor 26 is configured to parse the prompt 22 and create a parse tree of the content contained therein. Preprocessor directives can be inserted into the prompt 22 to identify the first prompt portion 28, second prompt portions 30, and provenance metadata 29 prior to processing by the preprocessor 26, for example, to enable the preprocessor 26 to create the parse tree. After parsing the prompt 22, the preprocessor is configured to, at 26A, determine whether there is grounded content 52 referenced in the prompt by the first prompt portion 28 encoded in first input tokens 33A and associated provenance metadata 29 encoded in provenance metadata tokens 33A2. Upon making a positive determination, the preprocessor 26 is configured to call an associated grounded content module 42 of the model plugin 20. The grounded content module 42 is passed a link (e.g., URL or URI) to the grounded data source 44. The link may include a network address, path, and one or more parameters or a state identifier (which may be obfuscated in a GUID for example) extracted from the provenance metadata 29 contained in tokenized first provenance metadata 33A2. Such a link may be referred to as a deep link. The grounded content module 42 uses this link to retrieve grounded content from the grounded data source 44 over computer network 46. Thus, the processing circuitry 12 can be configured to receive a parse tree that specifies respective locations of the first output portion 38A and the second output portion 38B in the output sequence 38. Following a determination that sufficient information has been obtained to proceed with generation of the output sequence by the machine learning model (Y at 26B), the model plugin 20 is configured to pass the tokenized prompt 33 with the input sequence 34 to the machine learning model 18 and generate the output sequence 38 as specified by the parse tree.

The processing circuitry 12 is further configured to generate an output sequence 38 of output tokens 40 at least in part by obtaining a first output portion 38A of the output sequence 38 from the grounded data source 44 indicated in the first provenance metadata 33A2. The processing circuitry 12 is further configured to, at the machine learning model 18, generate a second output portion 38B of the output sequence 38 based at least in part on the second prompt portion 33B and the retrieved first output portion 38A. The first output portion 33A contains first output tokens 40A and the second output portion 33B contains second output tokens 40B. It will be appreciated that the number of tokens is shown in simplified form for the input and output tokens, and thus where one token is shown, multiple tokens may be represented.

This generation by machine learning model 18 proceeds in an autoregressive token-wise generation loop 39 using transformer 18A until the output sequence 38 is completed. Transformer 18A on each pass through the generation loop produces a probability distribution of candidate tokens for the next output token in the output sequence 38. One of the candidate tokens is sampled according to a sampling function, which may take one or more sampling parameters, such as a temperature parameter, as an input to adjust the sampling method. The process proceeds on the generation loop 39 until the machine learning model 18 has completed generation of the output sequence 38. In this manner, by implementing the machine learning model 18, the processing circuitry 12 is configured to compute the second output portion 38B via autoregressive generation based at least in part on the tokenized prompt 33, the probabilistically generated tokens selected thus far in the second output portion 38B of the output sequence 38, at each stage of the token-wise generation loop 39.

Once the output sequence 38 is completed, the machine learning model 18 is configured to transmit the output sequence 38 to an additional computing process, such as a file storage process, transmission process, display process, or downstream application process. As shown, the output sequence 38 can be passed through a tokenizer for detokenization, and a response 48 can be generated. The response 48 includes text data including model-generated content 50 based on the second output portion 38B of the output sequence 38, grounded content 52 based on the first output portion 38A of the output sequence 38, and a link 54 to the grounded data source 44, which also can be encoded in the first output portion 38A.

Response 48 can be output to prompt interface 24. Thus, in one example, the additional computing process mentioned above can be a graphical user interface (GUI), and the processing circuitry 12 can be configured to transmit the output sequence 38 for display at the GUI with the model-generated content 50 encoded in the first output portion 38B and the grounded content 52 encoded in the second output portion 38A indicated in a visually distinguishable manner. The text associated with the first output portion 38A can be labeled at the GUI with an indicator of the grounded data source 44, such as a link to the grounded data source 44. Examples of this are illustrated in FIG. 2 discussed below, where model-generated content is in plain text and grounded content is in bold text. Of course, other forms of emphasis could be used such as color, size, font, outlining, underlining, highlighting, citations, etc. In another example, the prompt interface can be an API or storage interface and the additional computing process can be a downstream computing program such as the prompt API or storage interface.

The computing system 10A can be configured to use the grounded content token insertion techniques described herein to insert a do-not-train tag 31 into the model output, to thereby prevent or inhibit training of third-party models based on the output of machine learning model 18 and/or of grounding data source 44. To this end, the processing circuitry 12 can be configured to tag the first output portion 38A with the provenance metadata 29 as first provenance metadata, and/or tag the second output portion 38B with second provenance metadata 29A indicating machine-learning-model-generated output. The processing circuitry 12 further can be configured to exclude the output sequence 38 from a training corpus of an additional machine learning model based at least in part on determining that the output sequence is tagged with the first provenance metadata 29 or the second provenance metadata 29A. This could be achieved by inserting do-not-train tag 31 associated with the first output portion 38A and/or second output portion 38B in the training data, as appropriate. In this way, the output of the machine learning model 18 and/or the output of the grounded data source 44 can be avoided when training the additional machine learning model.

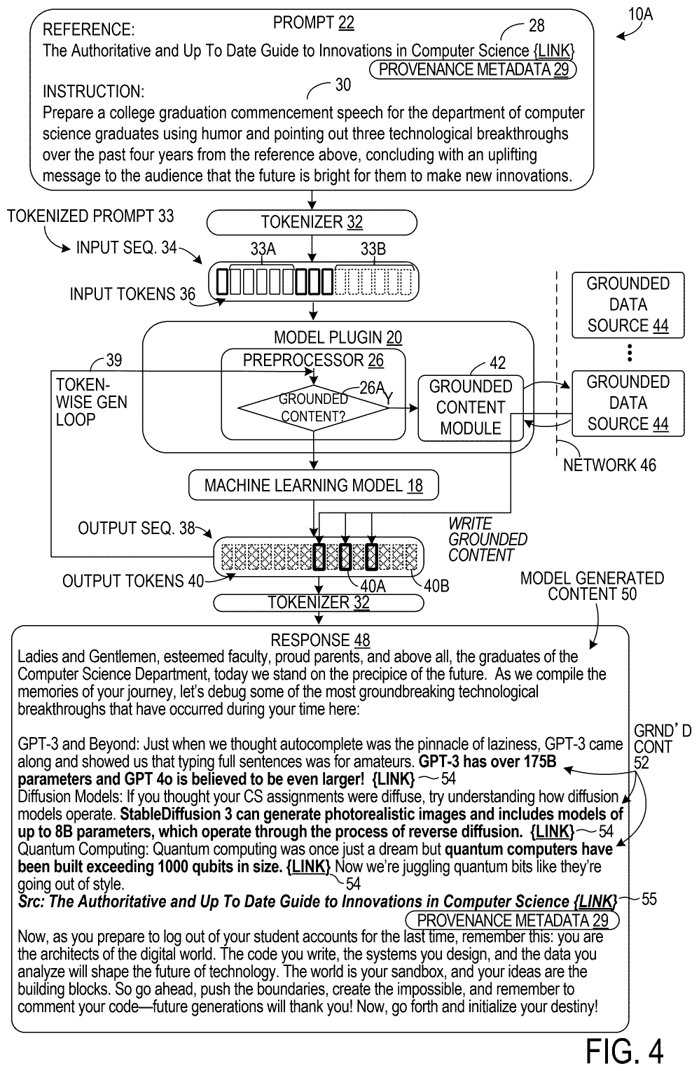

Turning now to FIG. 4, an example use case scenario for the computing system 10A with grounded token insertion is described. As shown, a prompt is received with first portion 28 including a reference to a learned treatise on computer science, titled “The Authoritative and Up To Date Guide to Innovations in Computer Science”. A textual reference to this learned treatise and a user accessible link to it online are included in prompt 22, along with provenance metadata 29, indicating a network location of this learned treatise at grounded data source 44. In a second portion 30 of prompt 22, an instruction is provided to generate a graduation commencement speech for computer science department graduates at a college graduation ceremony, with specific reference to three technological advances in computer science that occurred over the past four years as set forth in the referenced grounded content source.

Prompt 22 is tokenized to generate input sequence 34, which is passed to model plugin 20. Model plugin 20 executes the preprocessor 26, which in turn parses the tokenized prompt 22 and determines there is grounded content with provenance metadata 29 indicating a location of the grounded data source 44 containing the learned treatise referenced in the prompt (Y at 26A). The preprocessor 26 calls the grounded content module 42, which in turn retrieves information for “three technological breakthroughs from the reference.” Since this is a natural language description of the requested information from the grounded data source 44, a language model interface at the grounded data source 44 can be used to retrieve the information. Alternatively, a vector database comparison with similarity search and rank techniques can be employed to match this query to passages in the grounded data source 44. In this illustrated example, the following text is retrieved: (1) “GPT-3 has over 175B parameters and GPT-40 is believed to be even larger”, (2) “StableDiffusion 3 can generate photorealistic images and includes models of up to 8B parameters, which operate through the process of reverse diffusion”, and (3) “quantum computers have been built exceeding 1000 qubits in size” as well as the links associated with each. Following retrieval, tokenized text for these sentences was inserted into the output sequence 38 as grounded content tokens 40A, interleaved with model-generated tokens 40B.

To perform the insertion of the grounded content tokens 40A into the model-generated tokens 40B during the autoregressive token-wise generation loop 39, the input prompt is passed to the machine learning model 18, generation commences, and a parse tree for the output is generated and followed. The parse tree contains a template for insertion points for the grounded content. In this way, the grounded content is directly written into the output sequence 38, avoiding sending the grounded content through the machine learning model 18, thereby improving efficiency of the model due to reduced computations and improving accuracy due to not passing the grounded content through the probabilistic model generation process. The full text of the commencement speech generated by computing system 10A in response 48, including the interleaved model-generated content 50 and grounded content 52, is shown in FIG. 4.

FIG. 5 illustrates another example configuration of computing system 10A, including a postprocessor 27 of model plugin 20. In this configuration, a prompt 22 is prepared including a first portion 28 that includes a reference to a database 60. The reference to the database includes structured text with a SQL query to retrieve data from a column and row of a particular table, and a link to the table. Provenance metadata 29 in the prompt includes a network address at which the database 60 serving as the grounded content source 44 is located. The prompt 22 further includes a second portion 30 including an instruction to prepare a paragraph about a company for an annual report, summarizing the company's products and office locations, and including the total number of company employees as retrieved from the referenced link to the database 60. The prompt 22 is tokenized and passed to the model plugin 20.

Preprocessor 26 processes the prompt to generate a parse tree and identify the grounded content in the first portion 28 and the instruction in the second portion 30. After determining that grounded content is referenced in the prompt 22, the preprocessor 26 calls the grounded content module 42 to insert a grounded content insertion indicator such as an insertion point token 40C at a location in the output sequence 38, where the grounded content will later be inserted. The input sequence 34 for the tokenized prompt is then passed to the machine learning model 18, which performs token-wise generation of the output sequence 38 in autoregressive token-wise generation loop 39. In turn the machine learning model 18 generates the output tokens in output sequence 40. After the entire output sequence 38 is generated (or alternatively after the output sequence up until the insertion point token 40C is generated) the post processor 27 of the model 18 calls grounded content module 42 to obtain a grounded output portion from the grounded data source 44, which in this case involves a database call to database 60 to select the data at the indicated row and column indicated in the provenance data 29. In this implementation, a database lookup operation is performed at the database 60 to retrieve and return the grounded content to the grounded content module 42. In some implementations the grounded data source 44 can be indicated in the grounded content insertion indicator, and the insertion point tokens 40C can spell out the location of the grounded data source 44. In such an implementation, the insertion point tokens 40C are replaced, and the output sequence is updated by replacing the grounded content insertion indicator with the grounded output portion. The updated output sequence 38U is converted to text through detokenization via tokenizer 32 and transmitted to an additional computing process, such as display, storage, or an API of a downstream application. As shown, the generated updated output sequence 38U is passed through the tokenizer for detokenization into text, and output as response 48. The depicted response 48 includes model-generated content 50 in the form of a description of the company as requested in the instruction in prompt 22, as well as the total number of employees retrieved from database 60, which is 450, as grounded content 52. A link to the grounded data source 44 from which the grounded content 52 was retrieved is also included.

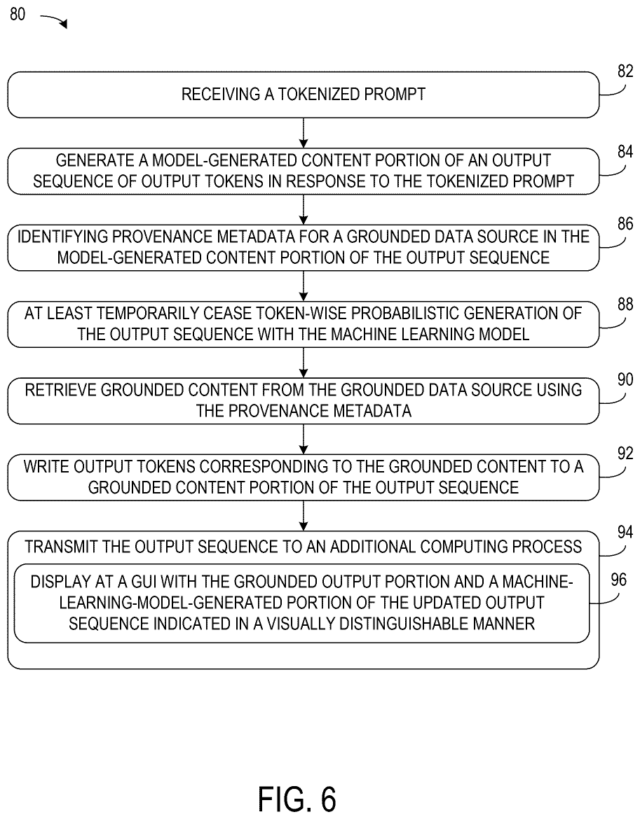

FIG. 6 illustrates a flowchart of a method 80 according to a first implementation of the present disclosure, for detecting provenance metadata in an output sequence of a machine learning model and using the provenance metadata to retrieve and insert grounded content into the output sequence. At 82, the method includes receiving a tokenized prompt at a machine learning model. At 84, the method includes generating a model-generated content portion of an output sequence of output tokens in response to the tokenized prompt. At 86, the method includes identifying provenance metadata for a grounded data source in the model-generated content portion of the output sequence. At 88, the method includes at least temporarily ceasing token-wise probabilistic generation of the output sequence with the machine learning model. At 90, the method includes retrieving grounded content from the grounded data source using the provenance metadata. At 92, the method includes writing output tokens corresponding to the grounded content to a grounded content portion of the output sequence. At 94, the method includes transmitting the output sequence to an additional computing process. As shown at 96, the additional computing process can be a graphical user interface (GUI), and the method can further include transmitting the output sequence for display at the GUI with the model-generated content portion and the grounded content portion indicated in a visually distinguishable manner. Further, the grounded content portion can be labeled at the GUI with an indicator of the grounded data source.

Method 80 can further include tagging the grounded content portion with the provenance metadata as first provenance metadata, and tagging the model-generated content portion with second provenance metadata indicating machine-learning-model-generated output. Further, the output sequence can be excluded from a training corpus of an additional machine learning model based at least in part on determining that the output sequence is tagged with the second provenance metadata.

The model-generated content portion can be a first model-generated content portion, and the method can further include, at the machine learning model, computing a second model-generated output portion via autoregressive generation based at least in part on a context including the tokenized prompt, the grounded content portion of the output sequence, and the first model-generated output portion. In some examples, the first provenance metadata includes author information associated with a verified user account. In other examples, the first provenance metadata includes a location of the grounded data source in a database, and the method further comprises obtaining the grounded content portion at least in part by performing a database lookup operation at the database.

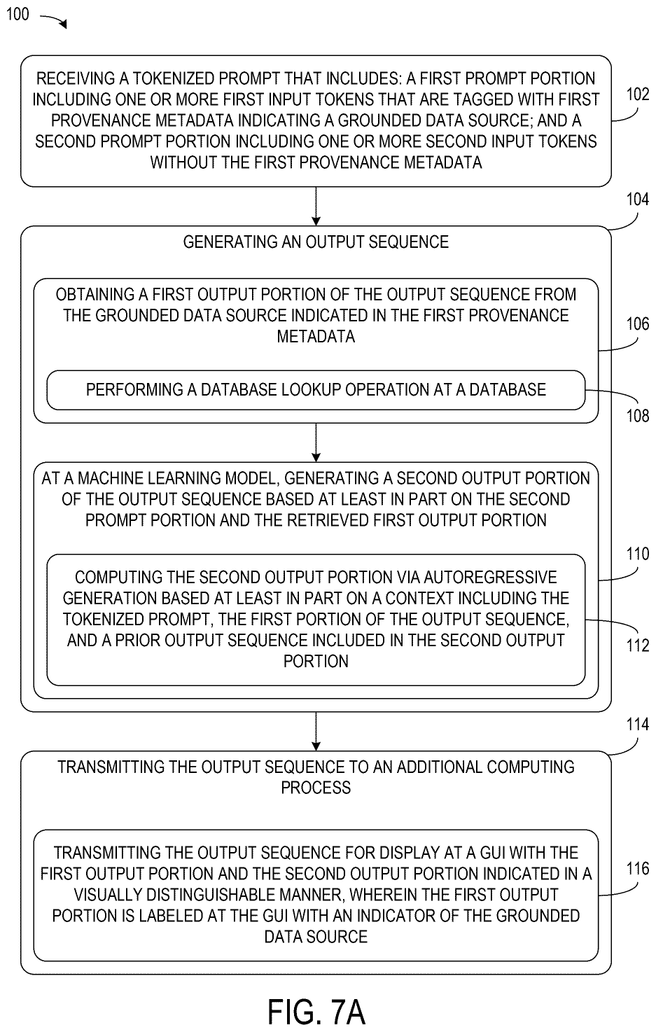

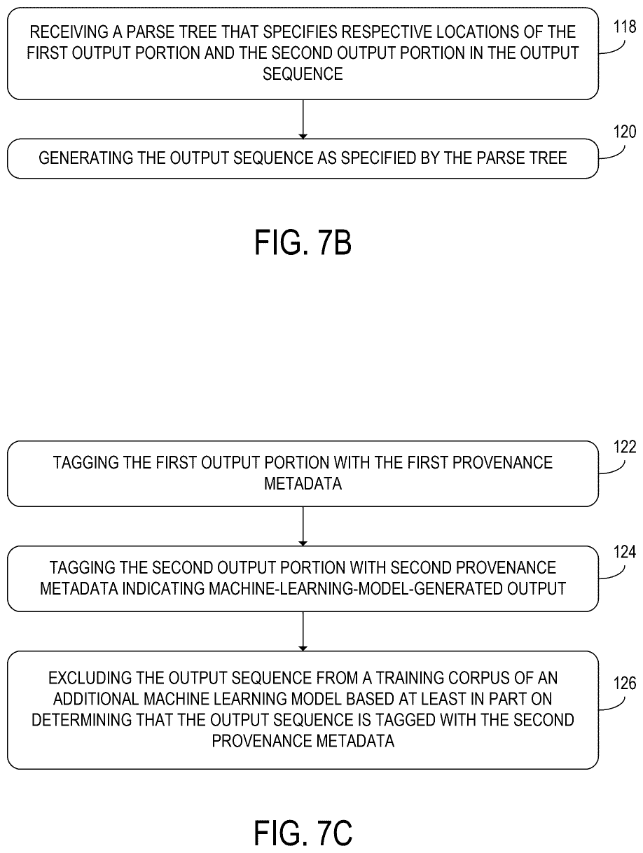

FIG. 7A shows a flowchart of a method 100 for use with a computing system to insert grounded content into a response generated at a machine learning model. Method 100 may be implemented using the above-described computer hardware and software components, or other suitable computer hardware and software. At step 102, the method 100 includes receiving a tokenized prompt. For example, the tokenized prompt may be computed at a tokenizer from a natural language input received at a GUI. The tokenized prompt includes a first prompt portion and a second prompt portion. The first prompt portion includes one or more first input tokens that are tagged with first provenance metadata indicating a grounded data source. The second prompt portion includes one or more second input tokens without the first provenance metadata.

In some examples, the first provenance metadata may include a location of the grounded data source in a database. As another example, the first provenance metadata may include author information associated with a verified user account. As another example, the first provenance metadata may include a hyperlink to the grounded data source. Thus, the first provenance metadata may be an annotation that indicates a grounded data source external to machine-learning-model-generated content.

At step 104, the method 200 further includes generating an output sequence based at least in part on the tokenized prompt. Generating the output sequence at step 104 includes, at step 106, obtaining a first output portion of the output sequence from the grounded data source indicated in the first provenance metadata. In examples in which the first provenance metadata indicates a location in a database, obtaining the first output portion at step 106 may include, at step 108, performing a database lookup operation at the database. In other examples, some other data structure or program may be used as the grounded data source.

At step 110, generating the output sequence at step 104 further includes generating a second output portion of the output sequence at a machine learning model. The machine learning model may be a large language model (LLM) or a large multimodal model (LMM). The second output portion is generated based at least in part on the second prompt portion and the retrieved first output portion. For example, at step 112, step 110 may include computing the second output portion via autoregressive generation based at least in part on a context. The context, in such examples, includes the tokenized prompt, the first portion of the output sequence, and a prior output sequence included in the second output portion. The prior output sequence is initialized as an empty set in a first autoregressive generation iteration and is constructed by iterative addition of second output tokens generated as part of the second output portion at subsequent autoregressive generation iterations. In examples in which step 112 is performed, the inclusion of the grounded content in the context may reduce hallucination during computation of the second output portion.

At step 114, the method 100 further includes transmitting the output sequence to an additional computing process. For example, the additional computing process may be a GUI. In such examples, step 114 may further include, at step 116, transmitting the output sequence for display at the GUI with the first output portion and the second output portion indicated in a visually distinguishable manner. In addition, the first output portion may be labeled at the GUI with an indicator of the grounded data source. Accordingly, the user may easily identify the grounded content and the machine-learning-model-generated content within the output sequence. In examples in which the first provenance metadata includes a hyperlink, the hyperlink may be provided to the user at the GUI as the indicator of the grounded data source. Thus, the user may quickly and easily refer to the grounded data source to verify the grounded content or obtain further information.

FIGS. 7B-7C show additional steps of the method 100 that may be performed in some examples. At step 118, as shown in FIG. 7B, the method 100 may further include receiving a parse tree that specifies respective locations of the first output portion and the second output portion in the output sequence. At step 120, the method 100 may further include generating the output sequence as specified by the parse tree. Thus, structures of grounded content insertion that are more complex than a single grounded content insertion location may be specified in the tokenized prompt. For example, nested citations of grounded content may be included in the output sequence.

FIG. 7C shows additional steps 122 and 124 that may be performed when generating the output sequence, as well as step 126, which may be performed subsequently to outputting the output sequence. At step 122, the method 100 may further include tagging the first output portion with the first provenance metadata. In addition, at step 124, the method 100 may further include tagging the second output portion with second provenance metadata indicating machine-learning-model-generated output.

Subsequently to outputting the output sequence, according to the example of FIG. 7C, the first output portion and the second output portion may be processed differently based on their metadata. At step 126, the method 100 may further include excluding the output sequence from a training corpus of an additional machine learning model based at least in part on determining that the output sequence is tagged with the second provenance metadata. The additional machine learning model may therefore be trained in a manner that avoids training on machine-learning-model-generated outputs that may include hallucinations.

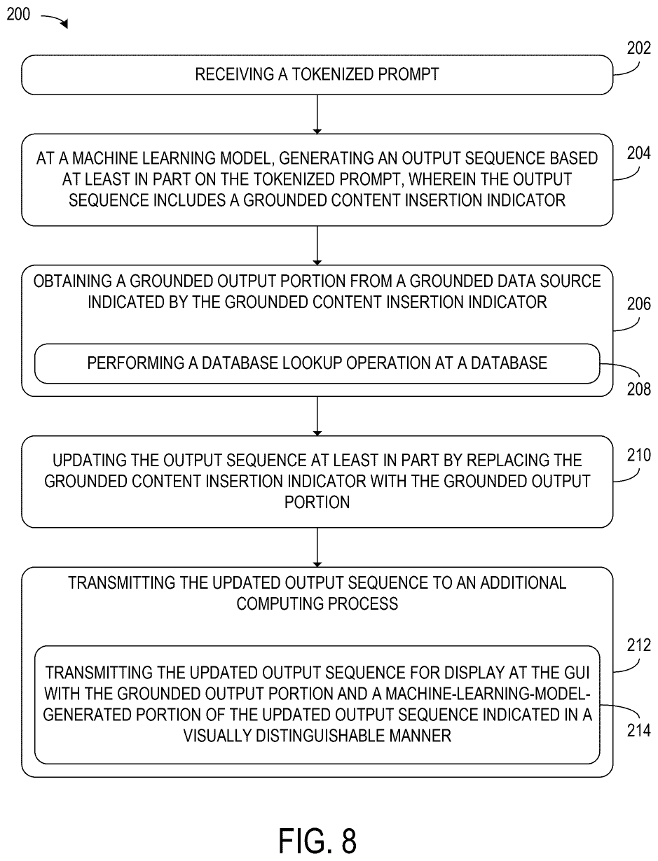

FIG. 8 shows a flowchart of a method 200 that may be performed in some examples as another approach to inserting grounded content into the output of a machine learning model. At step 202, the method 200 includes receiving a tokenized prompt.

At step 204, the method 200 further includes generating an output sequence at a machine learning model based at least in part on the tokenized prompt. The output sequence includes a grounded content insertion indicator, which may, for example, be an output token or a sequence of a plurality of output tokens. The grounded content insertion indicator specifies a grounded data source and acts as a placeholder for grounded content. In some examples, the output sequence includes a parse tree. In such examples, the parse tree may specify a structure in which the grounded content and machine-learning-model-generated content are arranged within the output sequence.

At step 206, the method 200 further includes obtaining a grounded output portion from the grounded data source indicated by the grounded content insertion indicator. For example, the grounded content insertion indicator may, in some examples, include a location of the grounded data source in a database. In such examples, step 206 may include, at step 208, obtaining the grounded output portion at least in part by performing a database lookup operation at the database. As another example, the grounded content insertion indicator may include author information associated with a verified user account. Grounded content received from the verified user account may be obtained at step 206 in such examples.

At step 210, the method 200 further includes updating the output sequence at least in part by replacing the grounded content insertion indicator with the grounded output portion. The grounded output portion may also be tagged with provenance metadata that specifies the grounded data source.

At step 212, the method 200 further includes transmitting the updated output sequence to an additional computing process. In some examples, the additional computing process may be a GUI. In such examples, the method 200 may further include, at step 214, transmitting the updated output sequence for display at the GUI with the grounded output portion and a machine-learning-model-generated portion of the updated output sequence indicated in a visually distinguishable manner. The grounded content may accordingly be indicated in a manner that is quickly and easily identifiable by the user. The grounded output portion may also be annotated with an indication of the grounded data source.

The above described systems and methods can be used to include a reference to grounded content and a grounded data source in a prompt 22 along with instructions for content generation via a machine learning model, to thereby cause the machine learning model to retrieve grounded content from the grounded content source and directly write the grounded into the output sequence of the model at appropriate locations, interleaved with model-generated content. The writing of the output tokens can be performed by a preprocessor 26 or postprocessor 26 of a model plugin as described above. Direct retrieval and writing to the output sequence of the grounded content in this manner achieves the technical effect of improving the efficiency of the machine learning model since the grounded content does not have to pass through the machine learning model during probabilistic inference, thereby reducing the computation resources, energy, and time used for inference, and also improves the accuracy of the model by passing the grounded content in an unadulterated form directly to the output sequence, without passing it through probabilistic generation. Further the trustworthiness and traceability of the model-generated content and grounded content are promoted by the inclusion of provenance metadata in the generated response. Further, by providing grounded content sources that have up-to-date information or private information sources, the content of generative models can be boosted with more recent, valuable, or salient information gleaned from these grounded content sources, in an efficient and accurate manner.

In some embodiments, the methods and processes described herein may be tied to a computing system of one or more computing devices. In particular, such methods and processes may be implemented as a computer-application program or service, an application-programming interface (API), a library, and/or other computer-program product.

The methods and processes described herein are tied to a computing system of one or more computing devices. In particular, such methods and processes can be implemented as a computer-application program or service, an application-programming interface (API), a library, and/or other computer-program product.

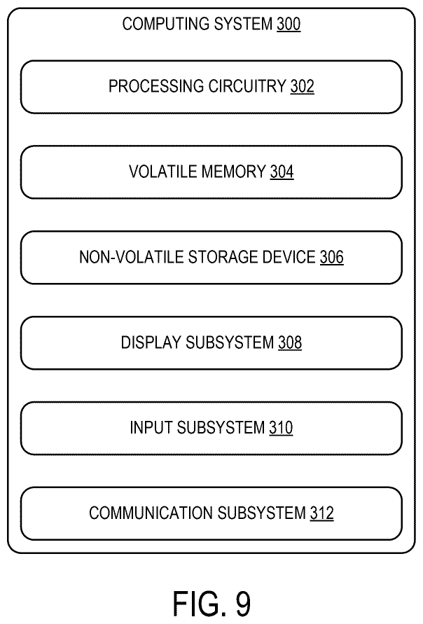

FIG. 9 schematically shows a non-limiting embodiment of a computing system 300 that can enact one or more of the methods and processes described above. Computing system 300 is shown in simplified form. Computing system 300 may embody the computing systems 10 and 10A described above. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 9.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, comprising processing circuitry and associated memory storing instructions that when executed cause the processing circuitry to: receive a tokenized prompt; generate a model-generated content portion of an output sequence of output tokens in response to the tokenized prompt; identify provenance metadata for a grounded data source in the model-generated content portion of the output sequence; at least temporarily cease token-wise probabilistic generation of the output sequence with the machine learning model; retrieve grounded content from the grounded data source using the provenance metadata; write output tokens corresponding to the grounded content to a grounded content portion of the output sequence; and transmit the output sequence to an additional computing process.

In this aspect, the additional computing process can be a graphical user interface (GUI); and the processing circuitry can be configured to transmit the output sequence for display at the GUI with model-generated content based on the model-generated content portion of the output sequence and grounded content based on the grounded content portion of the output sequence indicated in a visually distinguishable manner. Further in this aspect, the grounded content can be labeled at the GUI with an indicator of the grounded data source.

In this aspect, the provenance metadata can be first provenance metadata, and the processing circuitry can be further configured to: tag the grounded content portion with the first provenance metadata; and tag the model-generated content portion with second provenance metadata indicating machine-learning-model-generated output. Further in this aspect, the processing circuitry can be further configured to exclude the output sequence from a training corpus of an additional machine learning model based at least in part on determining that the output sequence is tagged with the second provenance metadata.

In this aspect, the model-generated content portion can be a first model-generated content portion, and at the machine learning model, the processing circuitry can be further configured to compute a second model-generated output portion via autoregressive generation based at least in part on a context including: the tokenized prompt; the grounded content portion of the output sequence; and the first model-generated output portion.

In this aspect, the provenance metadata can include author information associated with a verified user account.

In this aspect, the provenance metadata can include a location of the grounded data source in a database; and the processing circuitry can be further configured to obtain the grounded content output portion at least in part by performing a database lookup operation at the database.

In this aspect, the processing circuitry can be further configured to: receive a parse tree that specifies respective locations of the first output portion and the second output portion in the output sequence; and generate the output sequence as specified by the parse tree.

According to another aspect, a computing system is provided, comprising processing circuitry and associated memory storing instructions that when executed cause the processing circuitry to: receive a tokenized prompt; at a machine learning model, generate an output sequence based at least in part on the tokenized prompt, wherein the output sequence includes a grounded content insertion indicator; obtain a grounded output portion from a grounded data source indicated by the grounded content insertion indicator; update the output sequence at least in part by replacing the grounded content insertion indicator with the grounded output portion; and transmit the updated output sequence to an additional computing process.

In this aspect, the additional computing process can be a graphical user interface (GUI); and the processing circuitry can be further configured to transmit the updated output sequence for display at the GUI with grounded content based on the grounded output portion and model-generated content based on a machine-learning-model-generated portion of the updated output sequence indicated in a visually distinguishable manner.

In this aspect, the grounded output can be labeled at the GUI with an indicator of the grounded data source.

In this aspect, the grounded content insertion indicator can include author information associated with a verified user account.

In this aspect, the grounded content insertion indicator can include a location of the grounded data source in a database; and the processing circuitry is further configured to obtain the grounded output portion at least in part by performing a database lookup operation at the database.

According to another aspect, a method for use with a computing system is provided, the method comprising: receive a tokenized prompt; generate a model-generated content portion of an output sequence of output tokens in response to the tokenized prompt; identify provenance metadata for a grounded data source in the model-generated content portion of the output sequence; at least temporarily cease token-wise probabilistic generation of the output sequence with the machine learning model; retrieve grounded content from the grounded data source using the provenance metadata; write output tokens corresponding to the grounded content to a grounded content portion of the output sequence; and transmit the output sequence to an additional computing process.

In this aspect, the additional computing process can be a graphical user interface (GUI); and the method can further include transmitting the output sequence for display at the GUI with model-generated content based on the model-generated content portion and the grounded content based on the grounded content portion indicated in a visually distinguishable manner; and the grounded content can be labeled at the GUI with an indicator of the grounded data source.

In this aspect, the provenance metadata can be first provenance metadata, and the method can further comprising: tagging the grounded content portion with the first provenance metadata; tagging the model-generated content portion with second provenance metadata indicating machine-learning-model-generated output; and excluding the output sequence from a training corpus of an additional machine learning model based at least in part on determining that the output sequence is tagged with the second provenance metadata.

In this aspect, the model-generated content portion can be a first model-generated content portion, and the method can further comprise, at the machine learning model, computing a second model-generated output portion via autoregressive generation based at least in part on a context including: the tokenized prompt; the grounded content portion of the output sequence; and the first model-generated output portion.

In this aspect, the first provenance metadata can include author information associated with a verified user account.

In this aspect, the first provenance metadata can include a location of the grounded data source in a database; and the method can further comprise obtaining the grounded content portion at least in part by performing a database lookup operation at the database.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
processing circuitry and associated memory storing instructions that when executed cause the processing circuitry to:
receive a tokenized prompt;
generate a model-generated content portion of an output sequence of output tokens in response to the tokenized prompt;
identify provenance metadata for a grounded data source in the model-generated content portion of the output sequence;
at least temporarily cease token-wise probabilistic generation of the output sequence with a machine learning model;
retrieve grounded content from the grounded data source using the provenance metadata;
write the output tokens corresponding to the grounded content to a grounded content portion of the output sequence; and
transmit the output sequence to an additional computing process.

2. The computing system of claim 1, wherein:
the additional computing process is a graphical user interface (GUI); and
the processing circuitry is configured to transmit the output sequence for display at the GUI with model-generated content based on the model-generated content portion of the output sequence and grounded content based on the grounded content portion of the output sequence indicated in a visually distinguishable manner.

3. The computing system of claim 2, wherein the grounded content is labeled at the GUI with an indicator of the grounded data source.

4. The computing system of claim 1, wherein the provenance metadata is first provenance metadata, and the processing circuitry is further configured to:
tag the grounded content portion with the first provenance metadata; and
tag the model-generated content portion with second provenance metadata indicating machine-learning-model-generated output.

5. The computing system of claim 4, wherein the processing circuitry is further configured to exclude the output sequence from a training corpus of an additional machine learning model based at least in part on determining that the output sequence is tagged with the second provenance metadata.

6. The computing system of claim 1, wherein, the model-generated content portion is a first model-generated content portion, and wherein at the machine learning model, the processing circuitry is further configured to compute a second model-generated output portion via autoregressive generation based at least in part on a context including:
the tokenized prompt;
the grounded content portion of the output sequence; and
the first model-generated output portion.

7. The computing system of claim 1, wherein the provenance metadata includes author information associated with a verified user account.

8. The computing system of claim 1, wherein:
the provenance metadata includes a location of the grounded data source in a database; and
the processing circuitry is further configured to obtain the grounded content output portion at least in part by performing a database lookup operation at the database.

9. The computing system of claim 1, wherein the processing circuitry is further configured to:
receive a parse tree that specifies respective locations of the first output portion and the second output portion in the output sequence; and
generate the output sequence as specified by the parse tree.

10. A computing system comprising:
processing circuitry and associated memory storing instructions that when executed cause the processing circuitry to:
receive a tokenized prompt;
at a machine learning model, generate an output sequence based at least in part on the tokenized prompt, wherein the output sequence includes a grounded content insertion indicator;
obtain a grounded output portion from a grounded data source indicated by the grounded content insertion indicator;
update the output sequence at least in part by replacing the grounded content insertion indicator with the grounded output portion; and
transmit the updated output sequence to an additional computing process.

11. The computing system of claim 10, wherein:
the additional computing process is a graphical user interface (GUI); and
the processing circuitry is further configured to transmit the updated output sequence for display at the GUI with grounded content based on the grounded output portion and model-generated content based on a machine-learning-model-generated portion of the updated output sequence indicated in a visually distinguishable manner.

12. The computing system of claim 11, wherein the grounded output is labeled at the GUI with an indicator of the grounded data source.

13. The computing system of claim 10, wherein the grounded content insertion indicator includes author information associated with a verified user account.

14. The computing system of claim 10, wherein:
the grounded content insertion indicator includes a location of the grounded data source in a database; and
the processing circuitry is further configured to obtain the grounded output portion at least in part by performing a database lookup operation at the database.

15. A method for use with a computing system, the method comprising:
receive a tokenized prompt;
generate a model-generated content portion of an output sequence of output tokens in response to the tokenized prompt;
identify provenance metadata for a grounded data source in the model-generated content portion of the output sequence;
at least temporarily cease token-wise probabilistic generation of the output sequence with a machine learning model;
retrieve grounded content from the grounded data source using the provenance metadata;
write the output tokens corresponding to the grounded content to a grounded content portion of the output sequence; and
transmit the output sequence to an additional computing process.

16. The method of claim 15, wherein:
the additional computing process is a graphical user interface (GUI);
the method further includes transmitting the output sequence for display at the GUI with model-generated content based on the model-generated content portion and the grounded content based on the grounded content portion indicated in a visually distinguishable manner; and
the grounded content is labeled at the GUI with an indicator of the grounded data source.

17. The method of claim 15, wherein the provenance metadata is first provenance metadata, the method further comprising:
tagging the grounded content portion with the first provenance metadata; and
tagging the model-generated content portion with second provenance metadata indicating machine-learning-model-generated output; and
excluding the output sequence from a training corpus of an additional machine learning model based at least in part on determining that the output sequence is tagged with the second provenance metadata.

18. The method of claim 15, wherein the model-generated content portion is a first model-generated content portion, the method further comprising, at the machine learning model, computing a second model-generated output portion via autoregressive generation based at least in part on a context including:
the tokenized prompt;
the grounded content portion of the output sequence; and
the first model-generated output portion.

19. The method of claim 15, wherein the first provenance metadata includes author information associated with a verified user account.

20. The method of claim 15, wherein:
the first provenance metadata includes a location of the grounded data source in a database; and
the method further comprises obtaining the grounded content portion at least in part by performing a database lookup operation at the database.
